(19) United States
(12) Patent Application Publication
(10) Pub. No.: US 2021/0176818 A1
(43) Pub. Date: Jun. 10, 2021

(54) METHODS AND APPARATUS FOR CONNECTING COMPUTER AIDED DISPATCH SYSTEMS AND INTERNET-OF-THINGS SYSTEMS FOR PROVIDING EMERGENCY RESPONSE SERVICES

(71) Applicant: GenCore Candeo, Ltd., Tyler, TX (US)

(72) Inventors: Philip E. Burks, Tyler, TX (US); James Nipp, Tyler, TX (US); Chad Richey, Longview, TX (US)

(21) Appl. No.: 17/113,857

(22) Filed: Dec. 7, 2020

Related U.S. Application Data
(60) Provisional application No. 62/944,199, filed on Dec. 5, 2019.

(51) Int. Cl. H04W 76/50; H04W 4/90; H04W 4/029; B64C 39/02

(52) U.S. Cl. CPC H04W 76/50; H04W 4/90; B64C 2201/143; B64C 39/024; H04W 4/029

(57) ABSTRACT

Methods, systems and devices for connecting computer aided dispatch (CAD) systems for providing improved emergency response services are described. An example method includes connecting to a first CAD system and a second CAD system, wherein the information exchange interfaces associated with the first and second CAD systems are incompatible, and performing, using a common user interface overlay, the following operations: receiving an indication of an emergency situation, transmitting a list of available assets to the first CAD system, wherein the list of available assets comprises at least a set of available assets that are controlled by the second CAD system, receiving, from the first CAD system, a set of active assets designated to respond to the emergency situation, wherein the set of active assets is selected from the list of available assets, and transmitting, to the second CAD system, the set of active assets.

### CROSS-REFERENCE TO RELATED APPLICATION

The present application claims priority to and benefits of U.S. Provisional Patent Application No. 62/944,199, filed Dec. 5, 2019, the entirety of which is hereby incorporated by reference.

### TECHNICAL FIELD

The present application generally relates to coordination for emergency situation, and more particularly, to interfacing disparate emergency situation dispatchers and providers.

### BACKGROUND

In emergency situations, time is a precious and critical resource, and could often mean the different between life and death. Emergency responders, with specialized training, are among the first to arrive and provide assistance at the scene of an emergency situation, such as an accident or a natural disaster. Reducing the response time of the first responders can significantly improve the outcomes in emergency situations.

### SUMMARY

Embodiments of the disclosed technology relate to connecting computer aided dispatch (CAD) systems, or equivalently the corresponding public safety access point (PSAP), for providing improved emergency response services. In some embodiments, a user interface (UI) overlay with a common format may be used to connect each of a plurality of CAD systems to a cloud-based clearinghouse that enables the CAD systems to perform rapid and reliable two-way communication of critical emergency information without any of the CAD systems requiring an overhaul or upgrade.

In an example aspect, a method of communicating emergency information is described. The method includes connecting to a first computer-aided dispatch (CAD) system and a second CAD system, wherein an information exchange interface associated with the first CAD system is incompatible with an information exchange interface associated with the second CAD system, and performing, using a common user interface overlay, the following operations: receiving an indication of an emergency situation, transmitting a list of available assets to the first CAD system, wherein the list of available assets comprises at least a set of available assets that are controlled by the second CAD system, receiving, from the first CAD system, a set of active assets designated to respond to the emergency situation, wherein the set of active assets is selected from the list of available assets, and transmitting, to the second CAD system, the set of active assets.

In another example aspect, a system for communicating emergency information is described. The system includes a hosting center, a plurality of public safety access points (PSAPs), a processor coupled to the hosting center and each of the plurality of PSAPs, and a memory, coupled to the processor, including instructions stored thereupon, wherein the instructions upon execution by the processor cause the processor to connect to a first PSAP and a second PSAP, wherein an information exchange interface associated with the PSAP is incompatible with an information exchange interface associated with the second PSAP; and perform, using a common user interface overlay, the following operations: receive an indication of an emergency situation, transmit a list of available assets to the first PSAP, wherein the list of available assets comprises at least a set of available assets that are controlled by the second PSAP, receive, from the first PSAP, a set of active assets designated to respond to the emergency situation, wherein the set of active assets is selected from the list of available assets, and transmit, to the second PSAP, the set of active assets.

In yet another example aspect, the above-described method may be implemented by a processor coupled to a memory.

In yet another example aspect, these methods may be embodied in the form of processor-executable instructions and stored on a computer-readable program medium.

The subject matter described in this patent document can be implemented in specific ways that provide one or more of the following features.

### BRIEF DESCRIPTION OF THE DRAWINGS

FIG. 1 illustrates an environment of operation of the disclosed emergency responsiveness system.

FIG. 2 illustrates another environment of operation of the disclosed emergency responsiveness system.

FIG. 3 illustrates yet another environment of operation of the disclosed emergency responsiveness system.

FIGS. 4A-4H illustrate the example configurations of services, entities or agencies that can be connected to the disclosed emergency responsiveness system.

FIG. 5 illustrates examples of varying levels of connectivity between a service and the disclosed emergency responsiveness system.

FIG. 6 illustrates an example of the user interface (UI) overlay.

FIG. 7 is a flowchart illustrating an example of a set of operations for communicating emergency information.

### DETAILED DESCRIPTION

In an emergency situation, every second can be critical in saving lives and property. A dispatcher receiving a call related to an emergency situation typically has to be ready to make life-saving decisions within a very short time, e.g., sometimes within a few seconds. The decisions of a dispatcher are communicated electronically to other dispatchers and/or one or more first responders traveling via mobile emergency units to the location/scene of the emergency situation. First responders, mostly emergency medical services (EMS) providers, have contractual response time obligations associated with a type of emergency situation. In addition, most first responders may have internal response time standards against which they evaluate their performance. Further, given a particular type of emergency situation, the maximum allowable time to respond to the emergency can vary depending on scene/location corresponding to the emergency situation. For example, a life-threatening emergency call in an urban area may have an 8-minute response time requirement, whereas a non-life threatening emergency call may allow for a 10-minute response. In a non-urban area, a life-threatening emergency call may allow for a 15-minute response time, and a non-life threatening emergency call may allow up to a 20-minute response time.

Existing protocols for communication between two dispatchers is a manual and time-consuming process that can critically affect the required response times. Thus, it is important to design robust emergency awareness tools that allow different dispatching (or coordinating) entities to effectively and robustly communicate, thereby enabling first responders to arrive at the emergency scene in the shortest time possible, and more generally, ensure the efficient use of all available resources.

The following detailed description of the invention is merely exemplary in nature and is not intended to limit the invention or the application and uses of the invention. Furthermore, there is no intention to be bound by any particular theories or scenarios presented in the preceding background or the following detailed description.

For purposes of the discussions herein, responding to emergencies assumes the existence of a resource-sharing collaboration between a primary first responder who first receives a call related to an emergency situation and one or more secondary first responders who are assigned/deployed to the emergency situation. The primary first responder and the one or more secondary first responders share the resources of one another for assignment to an emergency situation. This allows heightened situational awareness that results in assignment of the closest, or most appropriate, mobile emergency unit to respond to the emergency situation. A secondary first responder is one that receives information relayed by the primary first responder for responding to an emergency situation to which the primary first responder is unable to respond due to some reason. Examples of reasons can be terrain, weather, the secondary first responder having a mobile emergency unit that happens to be passing through the location of the emergency, or any other reason which might require the need for resources from a secondary first responder. Indeed, it is contemplated that a first responder who is a primary first responder with respect to a given emergency situation may become a secondary first responder with respect to another emergency situation. Thus, the terms “primary” and “secondary” have no bearing on the capabilities of first responders. That is, given an emergency situation, the primary first responder is the one that first received notification of the emergency situation and relies on resources of one or more secondary first responders for assignment to the emergency situation.

In some embodiments, the primary first responder may choose to respond to the emergency itself, and the second first responder remains on standby or is notified that its services are no longer needed. However, existing systems require manual and time-consuming coordination between the primary and secondary first responders to deal with this emergency situation.

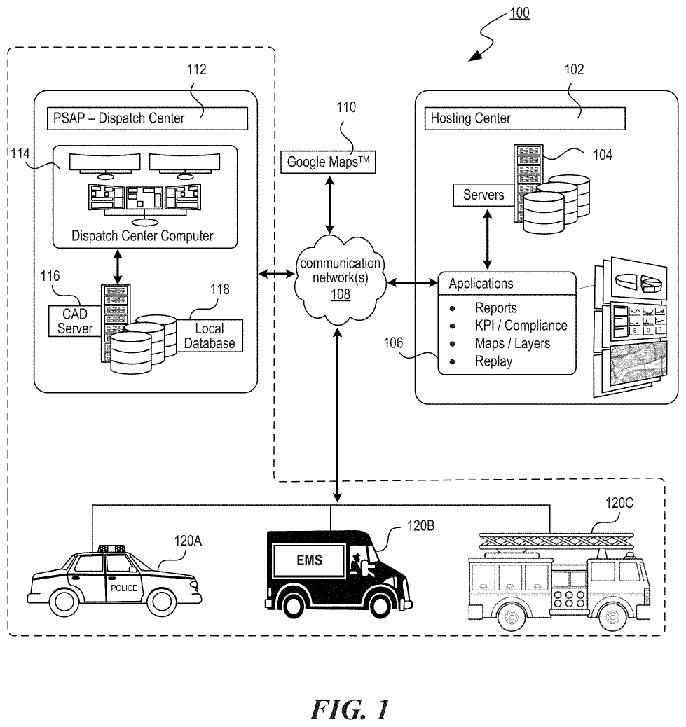

FIG. 1 illustrates a representative environment 100 of operation of the disclosed emergency responsiveness system. In some embodiments, the disclosed emergency responsiveness system includes a server-hosted deployment (e.g., at hosting center 102) in conjunction with local database(s) 118 at a dispatch center 112. Dispatch center 112 may include local databases 118, CAD server 116, and dispatch center computers 114. Hosting center 102 communicates with a dispatch center 112 via one or more communication networks 108 (such as the Internet). For example, hosting center 102 can pull from/push information relating to an emergency situation (in real time or near real time) from CAD server 116 and/or local databases 118 in dispatch center 112. For example, one or more computer-aided-dispatch (CAD) servers 116 coupled to local databases 118 of the emergency responsiveness system can process information associated with the emergency situation for assigning resources, such as one or more mobile emergency units (e.g., units 120A, 120B, 120C) to the emergency situation. Dispatch center 112 communicates with a mobile emergency unit via one or more communication networks 108 for tracking in real-time (or, near real-time) the location of a mobile emergency unit on a map that may be displayed on a graphical user interface (GUI) (e.g., viewed by a dispatcher at dispatch center 112) of the disclosed emergency responsiveness system. Such tracking can be done for any mobile emergency unit, e.g., whether they are stationary or mobile. For example, in connection with FIG. 1, dispatchers in dispatch center (or public safety access point (PSAP)) 112 can view/track mobile emergency unit 120A, 120B, 120C as they are assigned to respond to the same or different emergency situations. The disclosed emergency responsiveness system can generate the GUI that renders the tracking view to the dispatchers in dispatch center 112. An on-board GPS receiver, commonly referred to as automatic vehicle locator (AVL) located in a mobile emergency unit reports the location of the mobile emergency unit to hosting center 102 and/or dispatch center 112 for tracking purposes. In some embodiments, communications between the dispatch center 112 and the hosting center 102 are secured by a 256-bit encryption algorithm. In some embodiments, dispatch center 112 can access external servers 110 (e.g., Google maps or Waze) for weather, live traffic, road closures, crash notifications, and other relevant information. The hosting center 102 includes servers 104 that are configured to run one or more applications 106. Non-limiting examples of applications can be in connection with generating reports of emergency responsiveness, evaluating key performance indicators (KPI) and compliance to industry standards, running one or more mapping applications, tracking live vehicular movement of mobile emergency units, or replaying historical movement of mobile emergency units. For example, the reports can include analytics based on one or more parameters of the call associated with the emergency situation including a date, a type of call and timeliness of response to call. For example, KPI and compliance applications can automatically detect compliance of the responsiveness and alert when violations occur. In some embodiments, applications 106 can integrate one or more third-party applications. In some embodiments, data relating to vehicular movement of mobile emergency units is archived/stored at databases coupled with hosting center 102, in combination with (or, in lieu of) local databases 118 in dispatch center 112. In some embodiments, the hosting center can be remotely accessed (e.g., via a web-portal) for running one or more applications 106. Such accesses can be manual (e.g., requests by users of the disclosed emergency responsiveness system via a sign-in page) or electronic (e.g., requests by an application programming interface (API) communicatively coupled to the hosting center 112.)

It will be understood that although the discussions in FIG. 1 are in connection with one dispatch center that controls assignment of three mobile emergency units, such discussions are for illustrative purposes only. In alternate embodiments, there is no limitation on the number of dispatch centers and/or associated mobile emergency units. Furthermore, in different embodiments, the mobile emergency units can be for different types of first responders, e.g., law enforcement officials, medical units, fire units, paramedic units, tow trucks, electrical linemen, city/state transportation vehicles or any type of first responder.

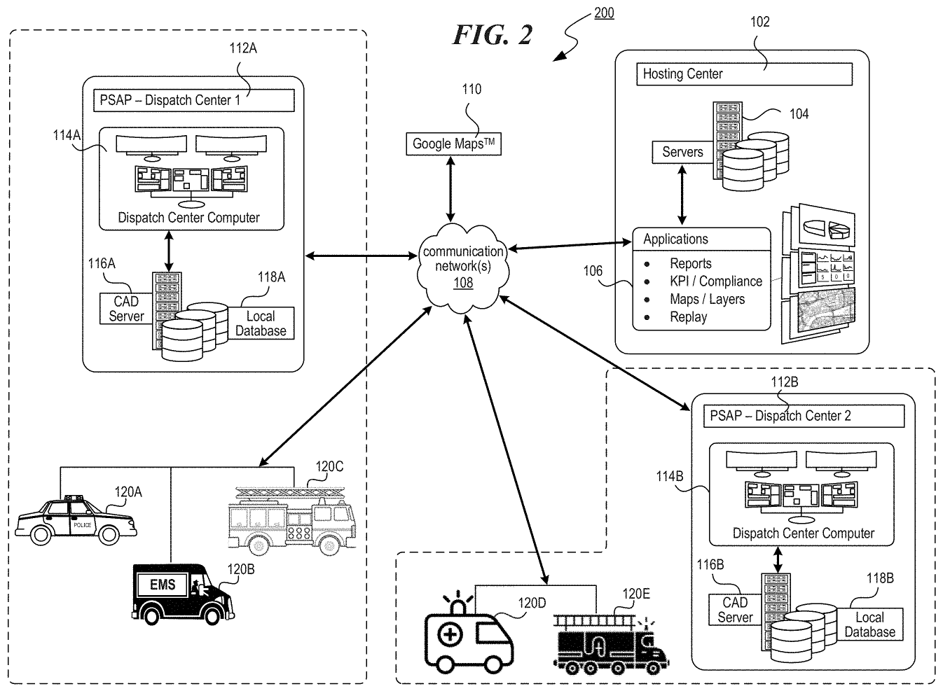

FIG. 2 illustrates another representative environment 200 of operation of the disclosed emergency responsiveness system. FIG. 2 shows dispatch center 1 (denoted 112A) and dispatch center 2 (denoted 112B) connected to the hosting center 102. Dispatch center 112A in FIG. 2 can be dispatch center 112 shown in FIG. 1. Dispatch center 112B includes similar components as dispatch center 112A, such as local database(s) 1186, CAD server 116B, and dispatch center computers 114B. FIG. 2 shows dispatch center 112B controlling the assignment of mobile emergency units 120D, 120E. FIG. 2 also shows that dispatch centers 112A and 112B are configured to run the disclosed emergency responsiveness system.

In some embodiments, the disclosed emergency responsiveness system provides an electronic platform for collaboration or partnership involving two or more first responders. In an example, a partnership is defined to be a collaboration in which a first responder shares (all or a portion of) its resources with other first responders. In another example, a partnership is defined as a collaboration between dispatch centers.

With reference to FIG. 2, dispatch center 112A can belong to a different first responder than the first responder that owns and operates 112B. For example, first responder A owns and operates dispatch center 112A and first responder B owns and operates dispatch center 112B. Accordingly, dispatchers in dispatch center 112A can view/monitor mobile emergency units 120A, 120B, 120C and dispatchers in dispatch center 112B can view/monitor mobile emergency units 120D, 120E. One or more benefits of partnership between first responders (such as first responder A and first responder B) can be better understood with the following illustrative example.

In a hypothetical scenario, dispatch center 112A of primary first responder A first receives a call for an emergency situation and secondary first responder B shares its resources (e.g., one or both mobile emergency units 120D, 120E) with first responder A. Also, it is assumed that mobile emergency units 120D, 120E are closer to the emergency situation location, than any of mobile emergency units 120A, 120B, or 120C. Based on partnership between first responder A and first responder B, dispatch center 112A can assign any (or both) mobile emergency units 120D, 120E to respond to the emergency situation. By sharing the location of their respective mobile emergency units with one another, situational awareness is heightened, and ultimately the closest, or otherwise most appropriate mobile emergency unit can be assigned to respond to an emergency situation, regardless of potential response boundaries (e.g., contractual response areas or jurisdictional boundaries). This can be crucial in providing greater reliability in mission-critical, life-saving moments. Furthermore, for emergency situations that require cooperation among different first responders (e.g., law enforcement, medical, fire, etc.) knowing where all responding units are located at any moment in time can be extremely beneficial to allow for interagency cooperation.

It will be understood that although the discussions in FIG. 2 are in connection with one first responder collaborating or partnering with one another first responder, such discussions are for illustrative purposes only. In alternate embodiments, there is no limitation on the number of first responders, or type of first responder, that a given first responder can collaborate or partner with. Also, the first responders involved in a partnership/collaboration can be serving in geographically adjacent or geographically non-adjacent areas. In some embodiments, a partnership can be between different first responders or even different divisions/departments of the same first responder organization.

Although the discussions in FIG. 2 focus on dispatchers associated with the first responder monitoring or viewing the first responder's resources, in alternate embodiments, dispatchers associated with partnering first responders can track the resources of one another. In connection with FIG. 2, this would imply that dispatchers in dispatch center 112A can view/monitor mobile emergency units 120D, 120E and dispatchers in dispatch center 112B can view/monitor mobile emergency units 120A, 120B, 120C.

Additionally, although the example in FIG. 2 assumes that mobile emergency units 120D, 120E are assigned to the emergency situation location because of their proximity, in alternate embodiments, other factors besides proximity can be used in considering which emergency units to deploy. Non-limiting examples of such factors are health condition of the crew in a mobile emergency unit, situation-handling expertise/experience of the crew in a mobile emergency unit, quality/quantity of available supplies in a mobile emergency unit, condition of the mobile emergency unit, and the like.

In most current emergency response service implementations, the CAD server 116A in PSAP 112A is typically not directly connected to CAD server 116B in PSAP 112B. That is, if PSAP 112A were to receive a call, it would enter the relevant information into the CAD server 116A, but would have to manually notify PSAP 112B about the situation (using either telephone or the public safety radio system) in order for PSAP 112B to dispatch resources (e.g., mobile emergency units 120D and 120E) or monitor the situation. Furthermore, these existing methods of communication (e.g., telephone or the public safety radio system) may result in transcription errors when information is being transferred from one CAD to another CAD. This will result in time lost and potentially be detrimental to the patient/victim if, for example, resources are dispatched to the wrong address.

In the event that CAD servers 116A and 116B are directly connected, the interface between the two systems is typically a custom and/or proprietary solution that cannot be then used to connect CAD server 116A with a different CAD server 116C (not shown in FIG. 2) without considerable expense. In effect, each CAD server or system is typically designed using proprietary software or is running different versions of the software, which makes communication between PSAPs time-consuming and cumbersome. This mismatch often results since each of the PSAPs and the corresponding CAD system is in a separate jurisdiction.

Embodiments of the disclosed technology provide methods and devices for connecting CAD systems to enable them to reliably and rapidly transfer critical emergency information without modifying the existing CAD server or system in the PSAP. For example, the communication network 108 in FIGS. 1 and 2 would host the embodiments described herein, which would advantageously allow, for example, CAD server 116A to seamlessly communicate with CAD server 116B.

That is, the described embodiments provide a standard (or common) data exchange format for electronically transferring information between two or more CAD systems without upgrading or overhauling the CAD systems, and in pursuit of replacing the current telephone-based protocol.

In some embodiments, the structure of this common data exchange format is interfaced with each CAD, which may be configured to present data in its own (possibly proprietary) format, and enables the CAD data format to be translated into the common data exchange format. That is, the common data exchange is a process that manages communication between two or more incompatible CADs via an interface that implements a defined set of structured data models related to common CAD resources, events and other CAD-related data, but can be extended to include information from many other sources as well. Data pertaining to an emergency response from a source CAD is translated to one or more structured data models, with unnecessary information removed before entering the common data exchange and being shared with other involved CADs.

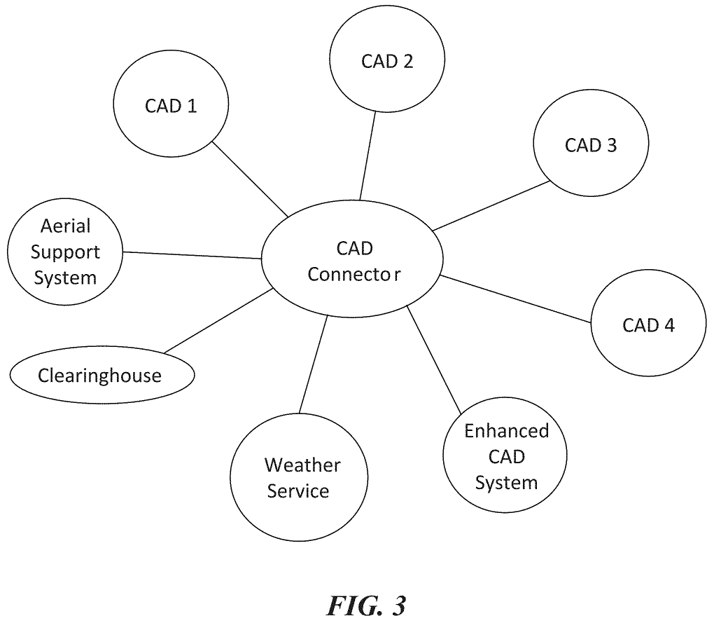

FIG. 3 illustrates yet another environment of operation of the disclosed emergency responsiveness system, which expands the environment shown in FIGS. 1 and 2 to. As shown therein, an interface, referred to herein as a CAD Connector is connected to a variety of different entities, services or agencies, which may include CAD 1, CAD 2, CAD 3, CAD 4, an enhanced CAD system, weather services, a clearinghouse and an aerial support system.

In an example, the enhanced CAD system is an emergency response center software that can connect to the CAD Connector to provide, for example, other agencies with real-time crash updates along relevant routes. In some embodiments, the enhanced CAD system provides an electronic platform for collaboration or partnership involving two or more first responders, and can be configured to provide a ranked list of potential candidates than can be assigned to respond to the incident. In an example, the enhanced CAD system is implemented and marketed as Genesis Pulse. Additional details related to the enhanced CAD system are available in U.S. Pat. No. 10,522,023, the entirety of which is incorporated by reference.

In another example, the clearinghouse, which is a secure source of data for emergency communications, can connect to the CAD Connector to provide, for example, information to enable faster response times and better situational awareness. In some embodiments, the clearinghouse receives data from the Internet of Things (smartphones, connected cars, wearables, and connected homes) and securely sends the relevant data to 9-1-1 and first responders. In an emergency, precise location and rich data (when available) is transmitted to the clearinghouse from enabled devices. In an example, the clearinghouse is implemented and marketed as RapidSOS Clearinghouse.

In yet another example, the aerial support system provides autonomous drone fleets that connect to the CAD Connector to provide, for example, critical situational awareness for first responders. In some embodiments, drones can be deployed to relay aerial images and video of an incident, thereby providing “eyes on the ground” which can allow emergency dispatchers with information about how to handle the emergency and what resources are necessary to get the incident under control. Some implementations of the aerial support system includes drones that are capable of vertical takeoff and landing, and include an emergency recovery system including a mechanism to deploy a parachute in an event of a failure of the on-board autopilot. In an example, the aerial support system is implemented and marketed as First iZ. Additional details related to the aerial support system are available in US Patent Publication No. 2018/0327091, the entirety of which is incorporated by reference.

In yet another example, the CAD Connector may be connected to other Internet-of-Things (IoT) systems. In an example, IoT systems can include home automation, smart power grids, smarter transportation assets, smarter workplaces, performance tracking, and smarter supply chains. Embodiments of the CAD connector can receive information from devices within each of these applications, thereby enabling improved product quality in manufacturing, improved predictive maintenance of device, improved environmental management, improved tracking of human health, reduced energy usage and improved supply chain tracking.

In some embodiments, each of these entities and services may provide disparate and distinct services to deal with emergency situations, and embodiments of the disclosed technology enables the back-and-forth transfer of information between agencies thereby allowing the optimal use of the available resources. For example, the aerial support system may be designated as a secondary first responder, and having received emergency information through its CAD, may provide assistance via its drone fleet in scenarios that may need aerial oversight.

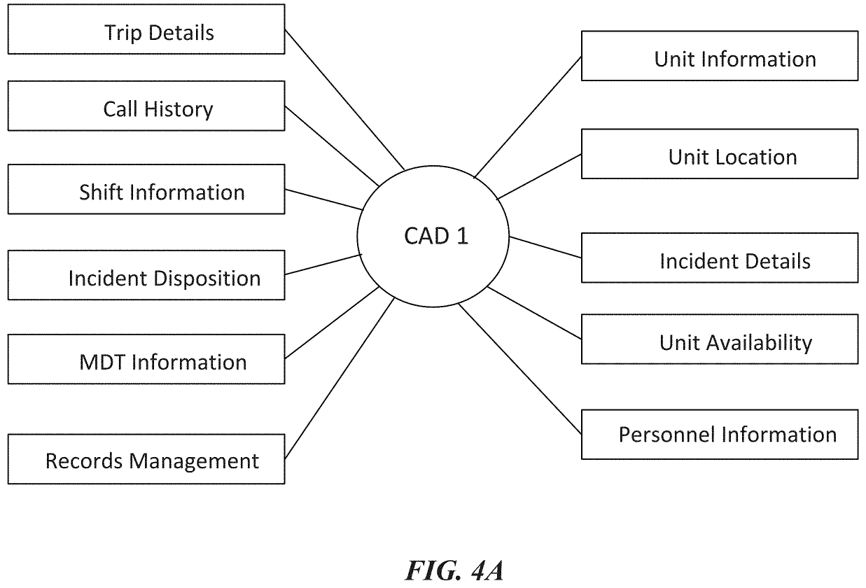

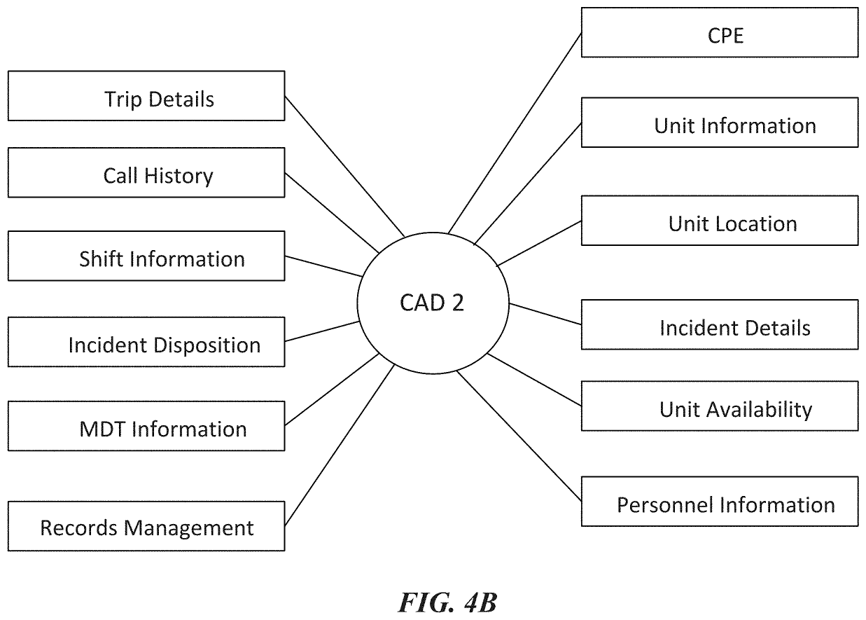

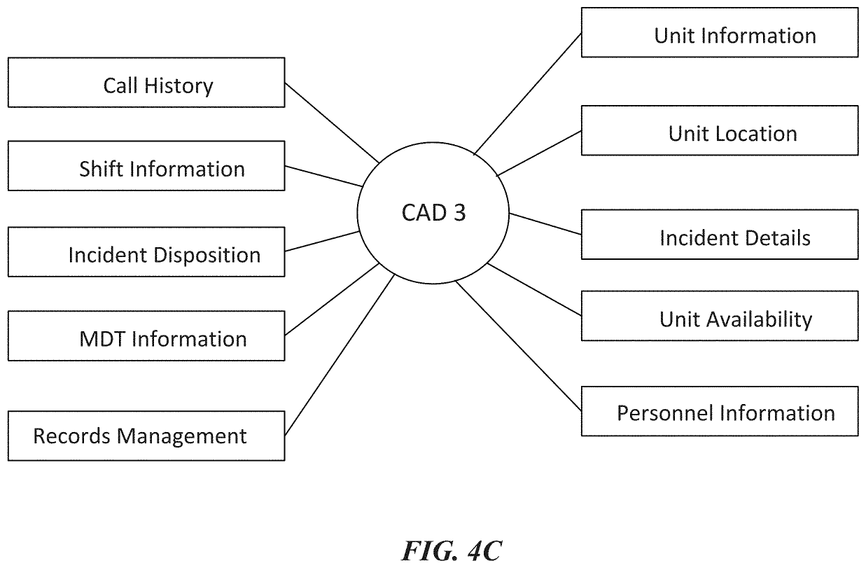

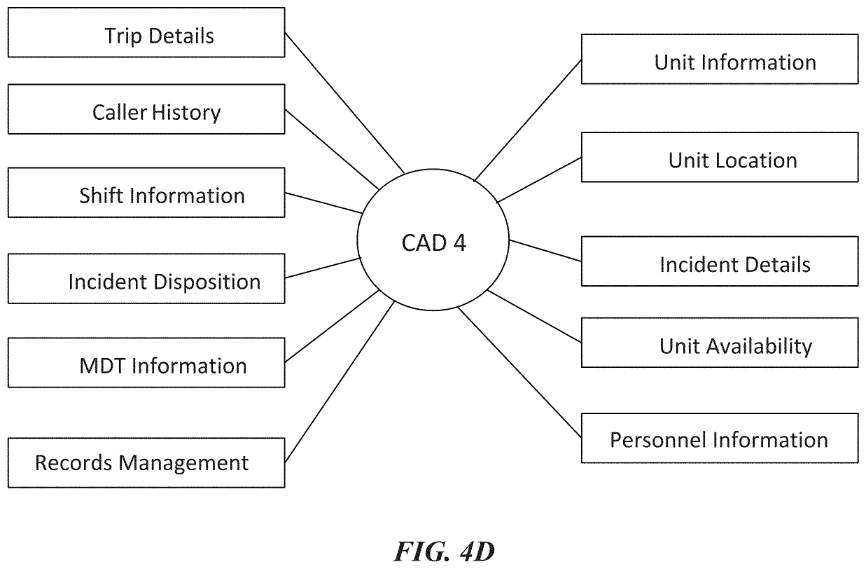

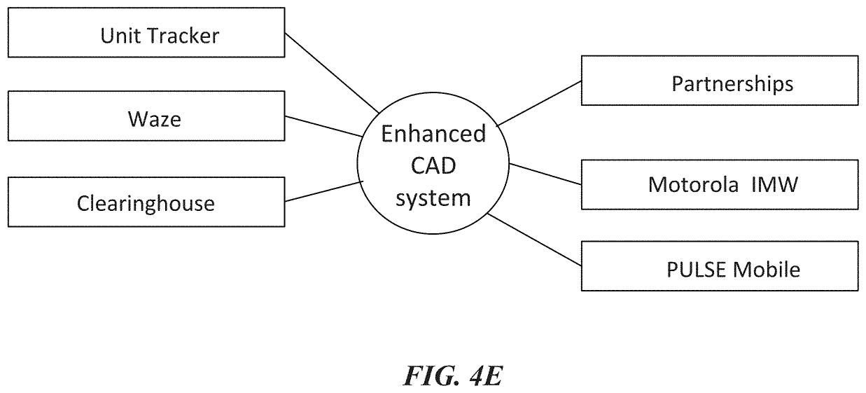

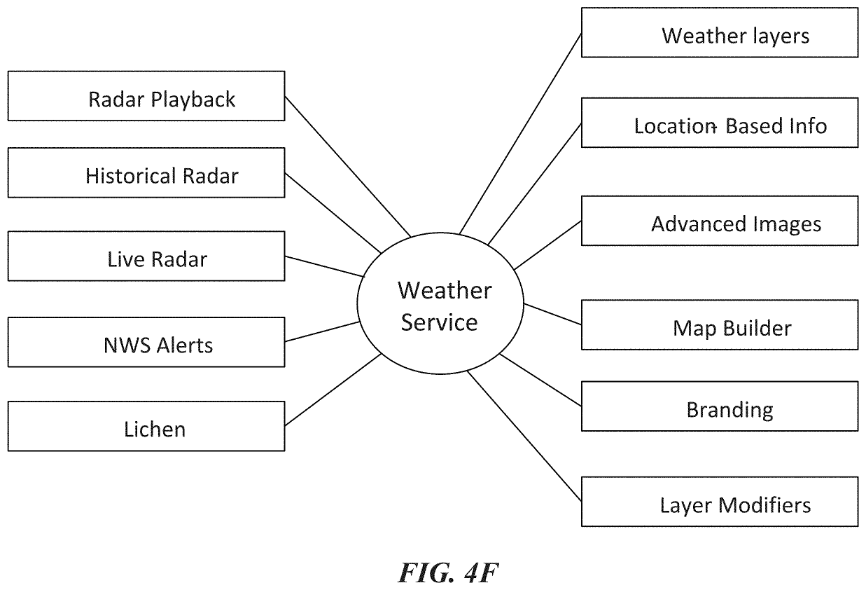

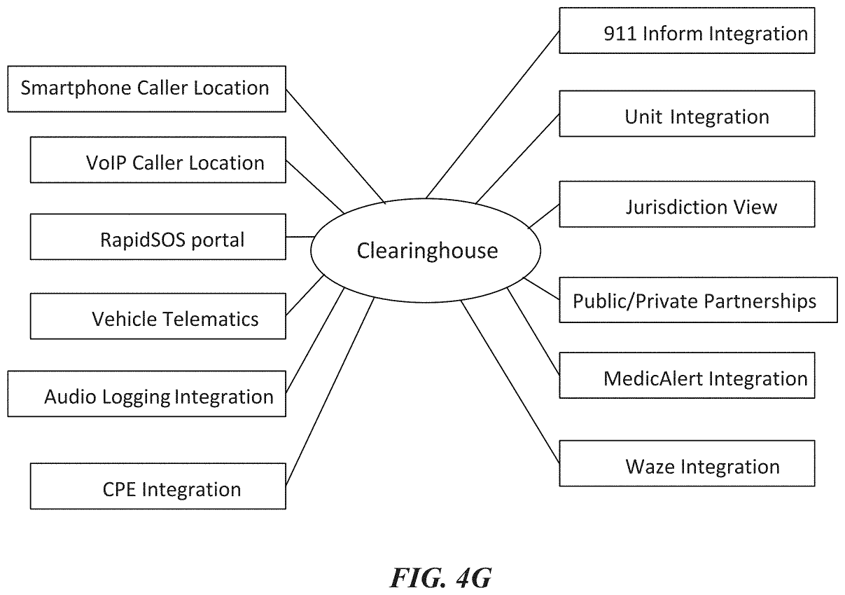

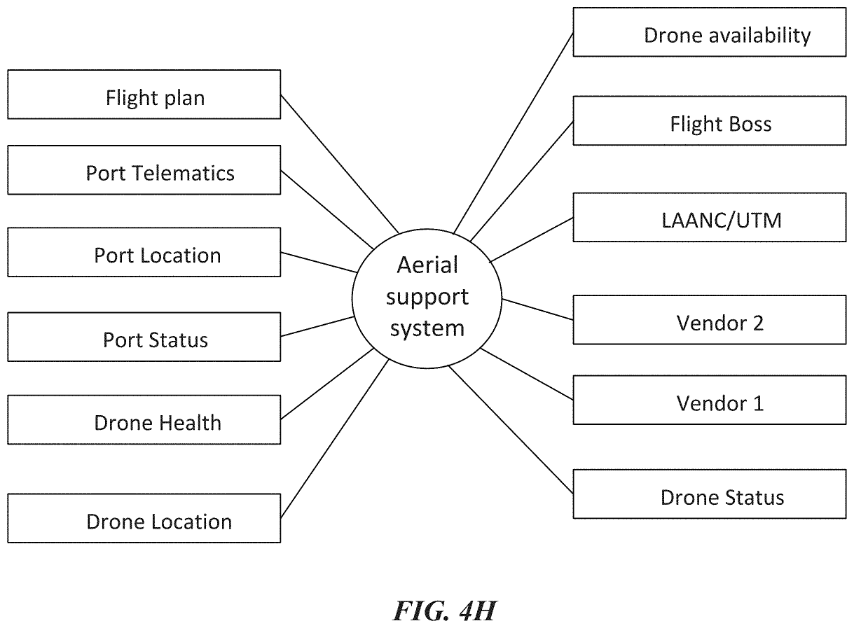

FIGS. 4A-4H illustrate examples of the various details that are shared by each of the different entities, services or agencies shown in FIG. 3. As seen therein, each participant shares data that is unique to their capabilities (e.g., the aerial support system shares flight telematics, drone availability and drone status, whereas the weather services share live radar, historical radar and weather layers), and has complete control of what is shared and with which other participants. In some embodiments, each participant that signs into the CAD Connector can provide a list of assets that may be leveraged by other participants as part of an emergency response service.

In an example, and as shown in FIG. 4A, CAD 1 can provide data related to its operational capabilities (e.g., trip details, incident disposition, records management, unit information and location, etc.), which can enable other partners to either leverage the resources CAD 1 has to offer or provide some of their own they are required to respond to a particular emergency.

In another example, and as shown in FIG. 4B, CAD 2 can provide data related to its operational capabilities (e.g., trip details, incident disposition, records management, CPE, unit information, location and availability, etc.), which can enable other partners to either leverage the resources CAD 2 has to offer or provide some of their own they are required to respond to a particular emergency.

In yet another example, and as shown in FIG. 4C, CAD 3 can provide data related to its operational capabilities (e.g., incident disposition and details, unit and shift information, personnel information, etc.), which can enable other partners to either leverage the resources CAD 3 has to offer or provide some of their own they are required to respond to a particular emergency.

In yet another example, and as shown in FIG. 4D, CAD 4 can provide data related to its operational capabilities (e.g., trip details, incident disposition, records management, unit information and location, etc.), which can enable other partners to either leverage the resources CAD 4 has to offer or provide some of their own they are required to respond to a particular emergency.

In yet another example, and as shown in FIG. 4E, the enhanced CAD system can provide data related to its operational capabilities (e.g., unit tracker, Waze, partnerships, connectivity with Motorola Intelligent Middleware (IMW), etc.), which can enable other partners to either leverage the resources the enhanced CAD system has to offer or provide some of their own they are required to respond to a particular emergency.

In yet another example, and as shown in FIG. 4F, the weather service can provide weather-related data (e.g., live and historical radar, National Weather Service (NWS) alerts, weather layers and modifiers, etc.) to the CAD Connector, which can distribute this information to other partners, thereby improving their response times and efficacy.

In yet another example, and as shown in FIG. 4G, the clearinghouse can provide assimilated information (e.g., smartphone caller location, VoIP caller location, vehicle telematics, integrations with other systems, etc.), which can enable other partners to either leverage the resources the clearinghouse has to offer or provide some of their own they are required to respond to a particular emergency.

In yet another example, and as shown in FIG. 4H, the aerial support system can provide resources (e.g., flight plans, port telematics and location, drone health, availability and location, etc.), which can enable other partners to either leverage the resources the aerial support system has to offer or provide some of their own they are required to respond to a particular emergency.

In some embodiments, other agencies that could sign into the CAD Connector include alarm companies. In an example, when an alarm is received, the relevant details could be fed directly into the CAD system at the dispatch center responsible for responding to the alarm event and create a call for service automatically in the CAD system, thereby preventing audible transcription errors over the telephone.

Embodiments of the disclosed technology provide a framework that is locally controlled and centrally managed. That is, each PSAP has local control with regard to its response to an emergency scenario that it is the primary first responder for. Any decisions related to the response to the emergency scenario are made at/within the PSAP, but disseminating a plan of action, for example, through the CAD Connector will result in neighboring agencies being rapidly notified of which resources are being currently used. Similarly, the PSAP can locally determine what information should be shared with other partner agencies. Based on the details provided, the amount of time the resources will be used may be determined. The central management of resources of the partner agencies advantageously enables efficient resource allocation while retaining local decision making (with regard to both sharing and deployment).

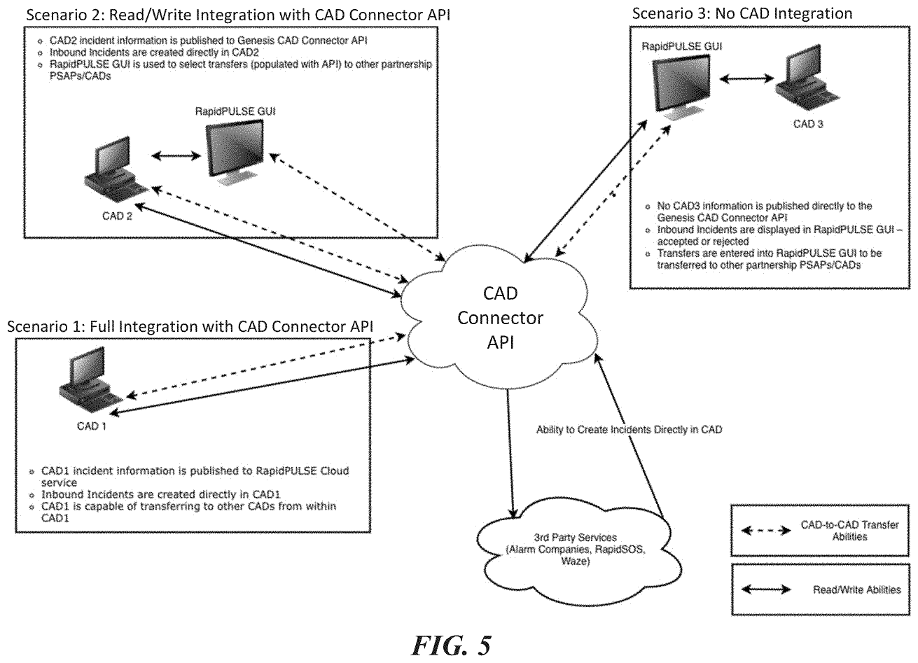

FIG. 5 illustrates examples of varying levels of connectivity between a service and the disclosed emergency responsiveness system. In Scenario 1, the CAD system is fully integrated with the CAD Connector, and is able to directly publish its incident information to the cloud-based CAD Connector service. In this fully integrated scenario, a CAD system is capable of transferring information or responsibilities to other CADs from within the CAD system itself.

In Scenario 2, the CAD system has read/write integration with the CAD Connector, and is able to directly publish its incident information to the cloud-based CAD Connector service. However, in this read/write integrated scenario, the CAD Connector GUI can be used to transfer information to other partners connected to the CAD Connector.

In Scenario 3, the CAD system is not integrated with the CAD Connector, and is unable to directly publish its incident information. In this unintegrated scenario, and similar to the protocols in Scenario 2, the CAD Connector GUI can be used to transfer information to/from other partners connected to the CAD Connector.

The rapid and reliable dissemination of information between CAD systems that run different software versions or different proprietary software is enabled, amongst other features, by the following:

### Cloud-Based Implementation

The CAD Connector is implemented as a cloud-based service, which allows it to be scalable (since there are ˜6900+PSAPs, each with a CAD system), provide better collaboration tools for the partner agencies, remain accessible more reliably, and provide better security and software tools. The cloud-based implementation facilitates the connection of the CAD Connector to other Internet-of-Things (IoT) systems.

In some embodiments, the cloud-based implementation will enable the centralized management of the CAD-to-CAD relationships, and development of rules and/or protocols regarding what data is to be shared and how.

### User Interface (UI) Overlay

The UI overlay advantageously enables disparate CAD systems to share information by providing an API (e.g., the CAD Connector API) that can be used to input the information or to gather the relevant information from the CAD system. Using the CAD Connector will not require a PSAP to change or upgrade the CAD system that is currently being used since the UI overlay interfaces with any existing CAD system. In an example, the vendor of the CAD system would provide middleware that enable the CAD system to interface with the UI overlay, thereby connecting it to the CAD connector.

If the middleware is unavailable from the vendor, embodiments of the disclosed technology can be configured to provide a separate GUI and data entry point for specific users so that they may access the CAD Connector API without having to change or overhaul their current CAD system.

In some embodiments, the UI overlay provides a common format for the CAD system to provide information in, which subsequently enables that information to be shared between different CAD systems at different PSAPs.

In contrast to existing systems that continue to rely on voice (or fax) protocols, embodiments of the disclosed technology leverage existing data terminals available in/at most emergency responders (e.g., police cars, ambulances, PSAPs, etc.). Using the UI overlay ensures that the initial recorded emergency information is accurately transmitted to partner agencies via the CAD Connector, and minimizes the effects of human error.

In some embodiments, the CAD Connector API will allow for any service to relay data directly to emergency call centers and then relay pertinent information back to these 3rd party services (call disposition, for example). These services could be alarm companies; smart buildings (door(s) locked/unlocked, room temperature, security camera feed, elevator status, power on/off, control lights, smoke alarm/carbon monoxide alarm status, ability to set off the internal/external alarm, etc.); smart cars/vehicle telematics (crash information—speed at time of crash, impact area, airbags deployed, number of seats occupied at time of crash, number of seats occupied post-crash, vehicle temperature, fire detection, precise location, etc.); wearable technology (smart watch information—precise location+altitude, EKG, heart rate, ambient temperature, fall alert metrics, eyeglasses with camera built-in with ability to feed a real-time video stream, etc.); state and federal alerts due to man-made incidents or natural disaster events (multi-casualty/mass casualty incidents); weather services or Waze.

Embodiments of the disclosed technology provide, amongst other features and benefits, the following:

### Single Point of Entry from CAD Systems Through the CAD Connector API

Existing CAD systems are built using different software versions or other proprietary software, whereas the CAD Connector acts as a single point of entry by providing an API with common format (e.g., using the UI overlay) that can be used to input information or gather information from the CAD system. The information can then be similarly disseminated to the partner agencies that were authorized to receive the information.

### CAD Connector API Allows Single Point of Entry for Other Vendors

As discussed in the context of FIGS. 3 and 4A-4H, the CAD Connector can be used to connect other systems, entities and agencies in addition to CAD systems. For example, other vendors that could sign up for the embodiments described herein include aerial support system dispatch (e.g., the aerial support system), commercial and residential alarm companies, voice loggers, other 9-1-1 equipment, IoT devices, FEMA or other federal agencies.

In some embodiments, the CAD Connector will serve as a new industry standard, whose protocols can be developed and specialized for sharing data between the partner agencies that have signed up to use the CAD Connector API.

### Two-Way Feed for the CAD Systems

In some embodiments, and in contrast to existing systems, CAD systems are connected using a bi-directional communication link that allows information to be shared back-and-forth between PSAPs based on, for example, the level of access granted by each PSAP to other PSAPs. The UI overlay would enable rapid and reliable two-way information sharing between CAD systems.

### Ease of Data-Sharing and Resource Allocation Between PSAPs

As discussed in an earlier example, a primary first responder may hand off an emergency response to a secondary first responder since its resources may be better suited to deal with that particular emergency. In existing systems, the primary first responder would be left with an “open ticket” that would not be resolved due to the lack of communication between the primary and secondary first responders. Embodiments of the disclosed technology enable the secondary first responder to allow providing progress notifications to the primary first responder. In a similar manner, the secondary first responder can provide updates regarding the assets it is using as part of the current emergency response. This advantageously enables the primary first responder to dispatch assets if the need arises.

More generally, a PSAP locally manages what information and data is shared with which partner agencies, e.g., the inputs and outputs of their CAD system that is connected to the CAD Connector.

### Resource Allocation from Partner Agencies

As discussed in the context of FIGS. 4A-4H, each partner entity and agency can provide a disparate set of assets based on their capabilities, and can select which ones can be leveraged by other partners for an emergency response. Embodiments of the disclosed technology enable each PSAP to locally determine how much information can be shared about its assets (e.g., status when responding to an emergency, availability information, etc.)

In some embodiments, partners can use the CAD Connector to dynamically invoke and/or assign assets that belong to other partner agencies during the normal flow of operations based on the rapid and reliable dissemination of information using the described embodiments.

### Geographically-Triggered Incident Reports

In some embodiments, a partner agency can monitor the incidents of neighboring agencies. Despite an agency not being the primary first responder that received the emergency call/request, an agency can track progress on that incident as well notifications of future incidents that occur in the surrounding area. This advantageously ensures that all available resources are being used in an optimal manner. In an example, recent wildfires in California have required assistance from multiple fire departments. These fire departments would be able to rapidly and reliably coordinate resources when a new wildfire starts, which is invaluable and can save persons and property from catastrophic damage.

### Visibility of Response Plans

As discussed earlier, the ability to track the response plan to an incident (e.g., the number of assets deployed in response to an emergency situation, the availability of additional resources of both the responding agency as well as neighboring agencies) results in more efficient use of the resources.

### Intra-Agency and Inter-Agency Communications

Embodiments of the disclosed technology enable FEMA and other federal agencies to gather information from multiple local agencies that have been affected by a widespread crisis (e.g., a hurricane or earthquake). In some embodiments, the local agency must first choose to share its data, and then FEMA can access any relevant data from the CAD Connector.

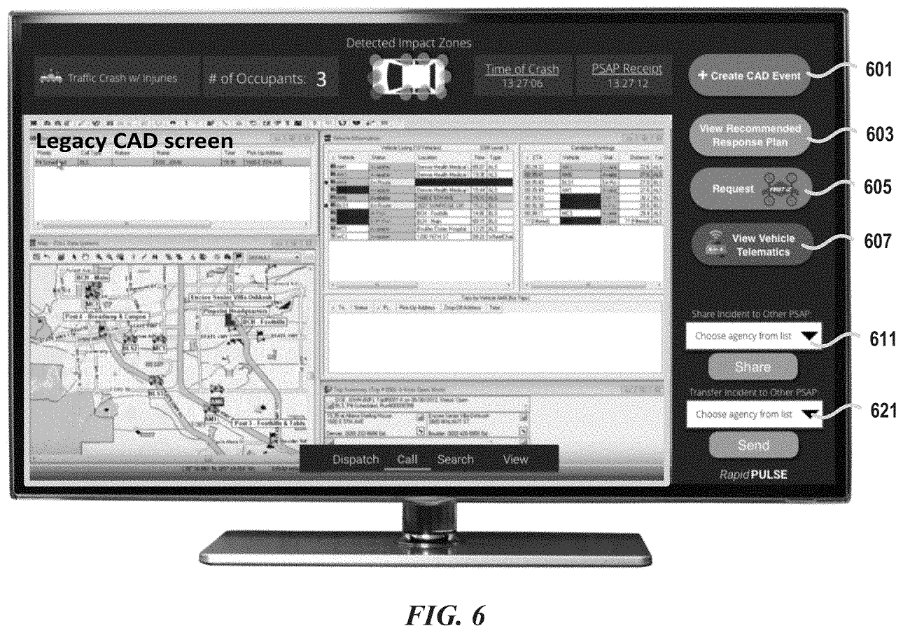

FIG. 6 illustrates an example of the UI overlay on a legacy CAD system screen. As shown therein, the legacy CAD screen includes a map with positions of emergency vehicles, indicators of incidents, etc. Other panels of the legacy CAD screen include vehicle and trip information for emergency vehicles that are part of the fleet of the PSAP using this CAD, as well as information regarding a current incident involving a vehicular crash.

The UI overlay surrounds the legacy CAD screen above and to the left in FIG. 6. As seen therein, the UI overlay is able to display information for the same incident that has been obtained from a 3rd party vendor and/or the car (e.g., a smart car) that is involved in the collision. The example shown in FIG. 6 represents Scenario 2 in FIG. 5, wherein the current CAD system has read/write integration with the CAD Connector.

As seen in FIG. 6, the UI overlay enables the CAD system user to create a CAD event (601), view a recommended response plan (603), request support from other CAD Connector partners (605, wherein drones from the aerial support system may be requested) and/or view vehicle telematics (607, wherein the smart car connectivity is leveraged). The user of the UI overlay for this CAD system in this PSAP is also able to share the incident with another PSAP (611) and/or transfer the incident to another PSAP (621).

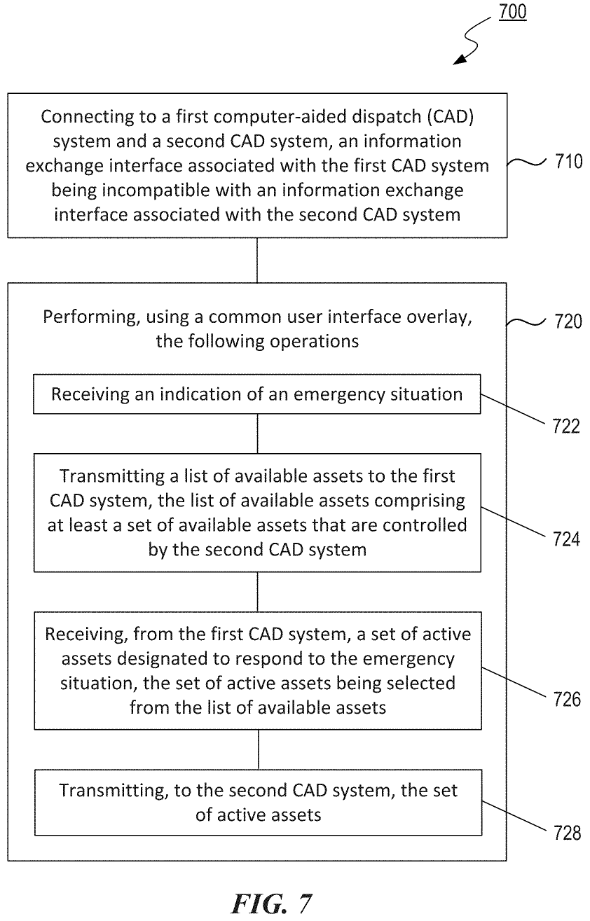

FIG. 7 is a flowchart illustrating an example of a set of operations 700 for communicating emergency information. The method 700 includes, at operation 710, connecting to a first computer-aided dispatch (CAD) system and a second CAD system, wherein an information exchange interface associated with the first CAD system is incompatible with an information exchange interface associated with the second CAD system.

The method 700 includes, at operation 720, performing, using a common user interface overlay, the following operations: receiving an indication of an emergency situation (722), transmitting a list of available assets to the first CAD system, wherein the list of available assets comprises at least a set of available assets that are controlled by the second CAD system (724), receiving, from the first CAD system, a set of active assets designated to respond to the emergency situation, wherein the set of active assets is selected from the list of available assets (726), and transmitting, to the second CAD system, the set of active assets (728).

In some embodiments, selecting the set of active assets is based on at least a location of the emergency situation.

In some embodiments, selecting the set of active assets is further based on nature of the emergency situation, capabilities of a crew of a set of available assets that are controlled by the first CAD system, and capabilities of a crew of the set of available assets that are controlled by the second CAD system.

In some embodiments, the second CAD system comprises an auxiliary system. In other embodiments, the method 700 further includes the operation of connecting to an auxiliary system.

In some embodiments, the auxiliary system is selected from the group consisting of a system configured to provide real-time crash updates along relevant routes to the location of the emergency situation, a system configured to provide aerial oversight of the emergency situation using an autonomous drone fleet, and a system configured to provide a secure source of data for emergency communications to enable faster response times and better situational awareness.

In some embodiments, the indication of the emergency is received through either the first CAD system or the second CAD system.

In some embodiments, the first CAD system and the set of available assets that are controlled by the first CAD system are associated with a first jurisdiction, and the second CAD system and the set of available assets that are controlled by the second CAD system are associated with a second jurisdiction that is different from the first jurisdiction.

In some embodiments, the common user interface overlay is associated with a common data exchange format that resolves the incompatibility between the information exchange interface associated with the first CAD system and the information exchange interface associated with the second CAD system.

Embodiments of the disclosed technology include a system for communicating emergency information, which includes a hosting center, a plurality of public safety access points (PSAPs), a processor coupled to the hosting center and each of the plurality of PSAPs, and a memory, coupled to the processor, including instructions stored thereupon, wherein the instructions upon execution by the processor cause the processor to connect to a first PSAP and a second PSAP, wherein an information exchange interface associated with the PSAP is incompatible with an information exchange interface associated with the second PSAP; and perform, using a common user interface overlay, the following operations: receive an indication of an emergency situation, transmit a list of available assets to the first PSAP, wherein the list of available assets comprises at least a set of available assets that are controlled by the second PSAP, receive, from the first PSAP, a set of active assets designated to respond to the emergency situation, wherein the set of active assets is selected from the list of available assets, and transmit, to the second PSAP, the set of active assets.

In some embodiments, the processor is implemented in a cloud-based service (e.g., as illustrated in FIGS. 1, 2 and 5).

In some embodiments, each of the plurality of PSAPs comprises a dispatch center computer, a computer-aided dispatch (CAD) server, and a local database, wherein the local database comprises a list of available assets and resources controlled by the corresponding PSAP.

In some embodiments, the hosting center is configured to track one or more emergency responders in real-time.

In some embodiments, the hosting center is further configured to generate one or more reports comprising emergency responsiveness statistics, key performance indicators, and compliance with industry standards.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. Also, many of the software modules can be provided as widgets to end users. For example, the candidate rankings tool and the system-wide summary of responsiveness to several emergency situations by different mobile emergency units in real-time or near real-time can be provided as widgets. The connectivity between the modules and/or components within the modules may be provided using any one of the connectivity methods and media that is known in the art, including, but not limited to, communications over the Internet, wired, or wireless networks using the appropriate protocols.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method of communicating emergency information, comprising:
connecting to a first computer-aided dispatch (CAD) system and a second CAD system, wherein an information exchange interface associated with the first CAD system is incompatible with an information exchange interface associated with the second CAD system; and
performing, using a common user interface overlay, the following operations:
receiving an indication of an emergency situation,
transmitting a list of available assets to the first CAD system, wherein the list of available assets comprises at least a set of available assets that are controlled by the second CAD system,
receiving, from the first CAD system, a set of active assets designated to respond to the emergency situation, wherein the set of active assets is selected from the list of available assets, and
transmitting, to the second CAD system, the set of active assets.

2. The method of claim 1, wherein selecting the set of active assets is based on at least a location of the emergency situation.

3. The method of claim 2, wherein selecting the set of active assets is further based on nature of the emergency situation, capabilities of a crew of a set of available assets that are controlled by the first CAD system, and capabilities of a crew of the set of available assets that are controlled by the second CAD system.

4. The method of claim 1, wherein the second CAD system comprises an auxiliary system.

5. The method of claim 1, further comprising:
connecting to an auxiliary system.

6. The method of claim 4 or 5, wherein the auxiliary system is selected from the group consisting of a system configured to provide real-time crash updates along relevant routes to the location of the emergency situation, a system configured to provide aerial oversight of the emergency situation using an autonomous drone fleet, and a system configured to provide a secure source of data for emergency communications to enable faster response times and better situational awareness.

7. The method of claim 1, wherein the indication of the emergency is received through either the first CAD system or the second CAD system.

8. The method of claim 1, wherein the first CAD system and the set of available assets that are controlled by the first CAD system are associated with a first jurisdiction, and wherein the second CAD system and the set of available assets that are controlled by the second CAD system are associated with a second jurisdiction that is different from the first jurisdiction.

9. The method of claim 1, wherein the common user interface overlay is associated with a common data exchange format that resolves the incompatibility between the information exchange interface associated with the first CAD system and the information exchange interface associated with the second CAD system.

10. A system for communicating emergency information, comprising:
a hosting center;
a plurality of public safety access points (PSAPs);
a processor coupled to the hosting center and each of the plurality of PSAPs; and
a memory, coupled to the processor, including instructions stored thereupon, wherein the instructions upon execution by the processor cause the processor to:
connect to a first PSAP and a second PSAP, wherein an information exchange interface associated with the PSAP is incompatible with an information exchange interface associated with the second PSAP; and
perform, using a common user interface overlay, the following operations:
receive an indication of an emergency situation,
transmit a list of available assets to the first PSAP, wherein the list of available assets comprises at least a set of available assets that are controlled by the second PSAP,
receive, from the first PSAP, a set of active assets designated to respond to the emergency situation, wherein the set of active assets is selected from the list of available assets, and
transmit, to the second PSAP, the set of active assets.

11. The system of claim 10, wherein the processor is implemented in a cloud-based service.

12. The system of claim 10, wherein each of the plurality of PSAPs comprises:
a dispatch center computer;
a computer-aided dispatch (CAD) server; and
a local database,
wherein the local database comprises a list of available assets and resources controlled by the corresponding PSAP.

13. The system of claim 10, wherein the hosting center is configured to track one or more emergency responders in real-time.

14. The system of claim 13, wherein the hosting center is further configured to generate one or more reports comprising emergency responsiveness statistics, key performance indicators, and compliance with industry standards.

15. The system of claim 10, further comprising:
an auxiliary system that is selected from the group consisting of a system configured to provide real-time crash updates along relevant routes to the location of the emergency situation, a system configured to provide aerial oversight of the emergency situation using an autonomous drone fleet, and a system configured to provide a secure source of data for emergency communications to enable faster response times and better situational awareness.

16. The system of claim 10, wherein the common user interface overlay is associated with a common data exchange format that resolves the incompatibility between the information exchange interface associated with the first PSAP and the information exchange interface associated with the second PSAP.

17. A non-transitory computer-readable storage medium having instructions stored thereupon for communicating emergency information, comprising:
instructions for connecting to a first computer-aided dispatch (CAD) system and a second CAD system, wherein an information exchange interface associated with the first CAD system is incompatible with an information exchange interface associated with the second CAD system;
instructions for performing, using a common user interface overlay, the following operations:
receiving an indication of an emergency situation,
transmitting a list of available assets to the first CAD system, wherein the list of available assets comprises at least a set of available assets that are controlled by the second CAD system,
receiving, from the first CAD system, a set of active assets designated to respond to the emergency situation, wherein the set of active assets is selected from the list of available assets, and
transmitting, to the second CAD system, the set of active assets.

18. The computer-readable storage medium of claim 17, wherein the indication of the emergency is received through either the first CAD system or the second CAD system, and wherein the indication is part of a 9-1-1 call, a fire alarm activation, or an Emergency Alert System (EAS).

19. The computer-readable storage medium of claim 17, wherein the common user interface overlay is associated with a common data exchange format that resolves the incompatibility between the information exchange interface associated with the first CAD system and the information exchange interface associated with the second CAD system.
